(19) United States
(12) Patent Application Publication
(10) Pub. No.: US 2015/0090104 A1
(43) Pub. Date: Apr. 2, 2015

(54) KEYBOARD APPARATUS FOR AN ELECTRONIC MUSICAL INSTRUMENT

(71) Applicant: YAMAHA CORPORATION, Hamamatsu-shi (JP)

(72) Inventors: Ichiro OSUGA, Hamamatsu-shi (JP); Hiroshi HARIMOTO, Hamamatsu-shi (JP)

(21) Appl. No.: 14/499,547

(22) Filed: Sep. 29, 2014

(30) Foreign Application Priority Data
Sep. 27, 2013 (JP) 2013-202401

(51) Int. Cl. G10H 1/34

(52) U.S. Cl. CPC G10H 1/34
USPC 84/744

(57) ABSTRACT

A keyboard apparatus has a plurality of white keys and black keys each of which pivot. The keyboard apparatus also has a plurality of reaction force generation members 21w and 21b provided for the white keys and the black keys, respectively. The reaction force generation members 21w and 21b have dome portions 21w1 and 21b1, respectively, which are thin and shaped like a dome so as to be elastically deformed by depression, and base portions 21w3 and 21b3, respectively, which are thick and are formed integrally with the dome portions 21w1 and 21b1 to support the dome portions 21w1 and 21b1, the base portions 21w3 and 21b3 jutting outward from respective lower end surfaces of the dome portions 21w1 and 21b1. The vertical position of the lower end of the dome portion 21w1 is displaced from the vertical position of the lower end of the dome portion 21b1.

### BACKGROUND OF THE INVENTION

1. Field of the Invention

The present invention relates to a keyboard apparatus for an electronic musical instrument, the keyboard apparatus having reaction force generation members for generating a reaction force by elastically deforming in response to a player's operation.

2. Description of the Related Art

Conventionally, there are keyboard musical instruments such as electronic organs and electronic pianos having rubber-dome reaction force generation members for exerting reaction force against the depression of keys. For example, Japanese Unexamined Patent Publication No. 11-175067 discloses a keyboard apparatus having reaction force generation members (key switches) each having a rubber dome on a circuit board fastened to a frame which supports keys located above the frame so that the keys can pivot. The reaction force generation members of white keys and black keys are configured the same. The reaction force generation members for black keys are located behind the reaction force generation members for white keys. Furthermore, the reaction force generation members are elastically deformed by being depressed by the keys depressed by a player, so that the player can perceive the same key touch on both the white keys and the black keys.

### SUMMARY OF THE INVENTION

However, the above-described conventional keyboard apparatus is configured such that the height of the reaction force generation members of the white keys is the same as the height of the reaction force generation members of the black keys, while the amount of stroke is different between the white keys and the black keys. Therefore, it is difficult for the conventional keyboard apparatus to provide the same key touch both on the white keys and the black keys. Furthermore, not only in the case of the above-described conventional apparatus but also in many cases, conventional apparatuses generally have a keyboard in which the structure is different between white keys and black keys, and more specifically, the length of each key, the amount of key-stroke, the position of an axis of the key and the like are different between the white keys and the black keys. In order to solve these problems, reaction force generation members whose size, shape, function and the like are different between white keys and black keys have to be employed. In a case where the dome-shaped reaction force generation members such as the above-described conventional art are employed, however, reaction force generation members whose size, shape, function and the like are almost the same both on white keys and black keys are required in order to provide a player with the same key touch both on the white keys and the black keys.

The present invention was accomplished to solve the above-described problems and to satisfy the request, and an object thereof is to provide a keyboard apparatus for an electronic musical instrument, the keyboard apparatus providing a player with almost the same key touch both on white keys and black keys. As for descriptions about respective constituent features of the present invention, furthermore, reference letters of corresponding components of embodiments described later are provided in parentheses to facilitate the understanding of the present invention. However, it should not be understood that the constituent features of the present invention are limited to the corresponding components indicated by the reference letters of the embodiments.

In order to achieve the above-described object, the present invention provides a keyboard apparatus for an electronic musical instrument, the keyboard apparatus including a plurality of keys composed of white keys (11w) and black keys (11b), each key pivoting about a corresponding pivot axis (Cw, Cb) so that a front end of the key can move up and down, and a plurality of reaction force generation members (21w, 21b) which are provided for the plurality of keys, respectively, and are made of an elastic body, and each of which is depressed by a depression of a corresponding key to generate a reaction force against the depression of the corresponding key, wherein each of the reaction force generation members has a dome portion (21w1, 21b1) which is thin and shaped like a dome so as to be elastically deformed by depression, and a base portion which is thick and is formed integrally with the dome portion to support the dome portion, the base portion extending downward seamlessly from all circumferences of a lower end of the dome portion to jut outward from a lower end surface of the dome portion; and a position of a point (Pw, Pw′) of intersection between the lower end surface of the dome portion of the white key and an axis line (Yw, Yb) of the dome portion of either the white key or the black key is displaced from a position of a point (Pb, Pb′) of intersection between the lower end surface of the dome portion of the black key and the axis line of the dome portion of the either key.

In this case, for example, a position of a point (Pw) of intersection between the lower end surface of the dome portion of the white key and the axis line of the dome portion of the white key may be displaced in a vertical direction of the keys from a position of a point (Pb) of intersection between the lower end surface of the dome portion of the black key and the axis line of the dome portion of the black key. Furthermore, the dome portion of the white key may have the same shape and size as the dome portion of the black key.

According to the present invention configured as above, by displacing the position of the point of intersection between the lower end surface of the dome portion of the white key and the axis line of the dome portion of either the white key or the black key from the position of the point of intersection between the lower end surface of the dome portion of the black key and the axis line of the dome portion of the either key, the lower end surface of the dome portion of the white key is substantially displaced from the lower end surface of the dome portion of the black key. As a result, the keyboard apparatus whose reaction force generation members for the white keys have a height different from the height of the reaction force generation members for the black keys can have the dome portions configured the same or roughly the same for both the white keys and the black keys to provide a player with roughly the same key touch on the white keys and the black keys.

It is another feature of the present invention that the position of the point of intersection between the lower end surface of the dome portion of the white key and the axis line of the dome portion of the white key is displaced in a direction in which the white key and the black key extend from the position of the point of intersection between the lower end surface of the dome portion of the black key and the axis line of the dome portion of the black key. As a result, the keyboard apparatus in which the reaction force generation members for the white keys are located in a position different in the direction in which the white keys and the black keys extend from the reaction force generation members for the black keys can provide a player with roughly the same key touch on the white keys and the black keys.

It is a further feature of the present invention that the reaction force generation members of the white keys are formed integrally with the reaction force generation members of the black keys; and the base portion of the white key is shaped differently from the base portion of the black key. In this case, for example, a step (21p, 21q) or slope (21r) may be provided between an upper surface of the base portion of the white key and an upper surface of the base portion of the black key. Only by providing the integrally formed reaction force generation members for the white keys and the black keys at a position with varying heights, as a result, the base portions of the white keys and the black keys can absorb the difference in height between the white keys and the black keys. Therefore, the keyboard apparatus not only provides a player with roughly the same key touch both on the white keys and the black keys, but also facilitates the assembly of the reaction force generation members.

It is a still further feature of the present invention that the reaction force generation members of the white keys are formed integrally with the reaction force generation members of the black keys; and an undersurface of the base portion of the white key and an undersurface of the base portion of the black key are seamlessly inclined in the direction in which the white key and the black key extend. Only by providing the integrally formed reaction force generation members for the white keys and the black keys at a position with required varying heights, as a result, the inclination of the undersurface of the base portions of the white keys and the black keys can absorb the difference in height between the white keys and the black keys. Therefore, the keyboard apparatus not only provides a player with roughly the same key touch both on the white keys and the black keys, but also facilitates the assembly of the reaction force generation members.

Furthermore, a feature of the present invention can be also understood as providing a keyboard apparatus for an electronic musical instrument, the keyboard apparatus including a plurality of keys composed of white keys (11w) and black keys (11b), each key pivoting about a corresponding pivot axis (Cw, Cb) so that a front end of the key can move up and down, and a plurality of reaction force generation members (21w, 21b) which are provided for the plurality of keys, respectively, and are made of an elastic body, and each of which is depressed by a depression of a corresponding key to generate a reaction force against the depression of the corresponding key, wherein each of the reaction force generation members has a body portion (21w1, 21b1) which is thin so as to be elastically deformed by depression, and a base portion (21w3, 21b3) which is thick and is formed integrally with the body portion to support the body portion, the base portion extending downward seamlessly from all circumferences of a lower end of the body portion to jut outward from the lower end of the body portion; and the lower end of the body portion of the white key is displaced in a vertical direction from the lower end of the body portion of the black key.

According to the feature of the invention, the keyboard apparatus in which the reaction force generation members for the white keys have a height different from the height of the reaction force generation members for the black keys can be configured such that the body portions for the white keys have the same or roughly the same configuration as the body portions for the black keys. As a result, the keyboard apparatus can provide a player with roughly the same key touch both on the white keys and the black keys.

### BRIEF DESCRIPTION OF THE DRAWINGS

FIG. 1 is a schematic side view of a keyboard apparatus according to the first embodiment of the present invention;

FIG. 2 is a schematic top view of the keyboard apparatus of FIG. 1;

FIG. 3 is an enlarged cross sectional view of reaction force generation members seen along a line 3-3 of FIG. 2;

FIG. 4 is a schematic side view of a keyboard apparatus according to the second embodiment of the present invention;

FIG. 5 is a schematic top view of the keyboard apparatus of FIG. 4;

FIG. 6 is an enlarged cross sectional view of reaction force generation members seen along a line 6-6 of FIG. 5;

FIG. 7 is a schematic side view of a keyboard apparatus according to the third embodiment of the present invention;

FIG. 8 is a schematic top view of the keyboard apparatus of FIG. 7;

FIG. 9 is an enlarged cross sectional view of reaction force generation members seen along a line 9-9 of FIG. 8;

FIG. 10 is an enlarged cross sectional view of a modification of the reaction force generation members of the third embodiment;

FIG. 11 is a schematic side view of a keyboard apparatus according to the fourth embodiment of the present invention;

FIG. 12 is a schematic top view of the keyboard apparatus of FIG. 11;

FIG. 13 is an enlarged cross sectional view of reaction force generation members seen along a line 13-13 of FIG. 12;

FIG. 14 is an enlarged cross sectional view of a modification of the reaction force generation members of the fourth embodiment;

FIG. 15 is a schematic side view of a keyboard apparatus according to the fifth embodiment of the present invention; and

FIGS. 16(A) and (B) are illustrations for explaining respective positions of lower end surfaces of dome portions of the reaction force generation members of a white key and a black key.

### DESCRIPTION OF THE PREFERRED EMBODIMENT

In the following, the invention will be further explained with the description of several embodiments of the invention. It is noted that although the embodiments do show the reaction force generation members as being embodied by an elastic dome construction, the invention is not limited to this implementation. The invention can be implemented using any suitable reaction force generation element. For example the reaction force generation element can include a spring member or an elastic element that generates a resisting force when actuated; for example a metal and/or plastic spring, a rubber and/or foam element, or an elastic rubber dome, or any other suitable material and/or construction, or combinations thereof. As in several embodiments, the reaction force generation elements can be the same for each key in the keyboard, but the invention is not limited to this implementation. Different reaction force generation elements can be used for any key, for example different ones for white and black keys, or for example different ones for the left and right side of the keyboard.

Further, the definition of the positions of the points (Pw, Pw′, Pb, Pb′) of intersection, which is described in the summary of the invention, will be explained as follows. The definition of the positions of the points of intersection were provided in order to define a difference in the direction of axis line between the lower end surface of the dome portion of the white key and the lower end surface of the dome portion of the black key. This will be explained with reference to FIG. 16. As indicated FIG. 16(A), a case where the axis line Yw of the dome portion 21w1 of the reaction force generation member 21w of the white key 11w is parallel with the axis line Yb of the dome portion 21b1 of the reaction force generation member 21b of the black key 11b will be explained. In this case, a difference ΔL in distance in the direction of the axis lines Yw and Yb between the respective lower end surfaces of the dome portions 21w1 and 21b1 can be defined as a distance in the direction of the axis lines Yw and Yb between the intersection point Pw between the lower end surface of the dome portion 21w1 and the axis line Yw, and the intersection point Pb between the lower end surface of the dome portion 21b1 and the axis line Yb. The difference ΔL in distance can be also defined as a difference in distance between the intersection point Pw between the lower end surface of the dome portion 21w1 and the axis line Yw, and an intersection point Pb′ between the lower end surface of the dome portion 21b1 and the axis line Yw, and can be also defined as a difference in distance between an intersection point Pw′ between the lower end surface of the dome portion 21w1 and the axis line Yb, and the intersection point Pb between the lower end surface of the dome portion 21b1 and the axis line Yb.

As indicated in FIG. 16(B), however, there are cases where the reaction force generation member 21b for the black key is assembled such that the reaction force generation member 21b for the black key is inclined against the reaction force generation member 21w for the white key. In such cases, the axis lines Yw and Yb are not parallel with each other. In such cases, therefore, the difference between the position of the lower end surface of the dome portion 21w1 in the direction of the axis line Yw and the position of the lower end surface of the dome portion 21b1 in the direction of the axis line Yb cannot be defined by use of the axis lines Yw and Yb. Therefore, the difference in position of the respective lower end surfaces of the dome portions 21w1 and 21b1 will be defined by use of either of the axis line Yw of the dome portion 21w1 or the axis line Yb of the dome portion 21b1, including the case where the axis lines Yw and Yb are parallel with each other. More specifically, a distance in the direction of the axis line Yw between the intersection point Pw between the lower end surface of the dome portion 21w1 and the axis line Yw, and the intersection point Pb′ between the lower end surface of the dome portion 21b1 and the axis line Yw will be defined. Alternatively, a distance in the direction of the axis line Yb between the intersection point Pb between the lower end surface of the dome portion 21b1 and the axis line Yb, and the intersection point Pw′ between the lower end surface of the dome portion 21w1 and the axis line Yb will be defined. In this case as well, furthermore, since the inclination of the axis line Yb against the axis line Yw is exaggerated in FIG. 16(B), there substantially exists a distance in the direction of the axis line Yw (or the axis line Yb) between the lower end surface of the dome portion 21w1 and the lower end surface of the dome portion 21b1 as in the case of FIG. 16(A).

### a. First Embodiment

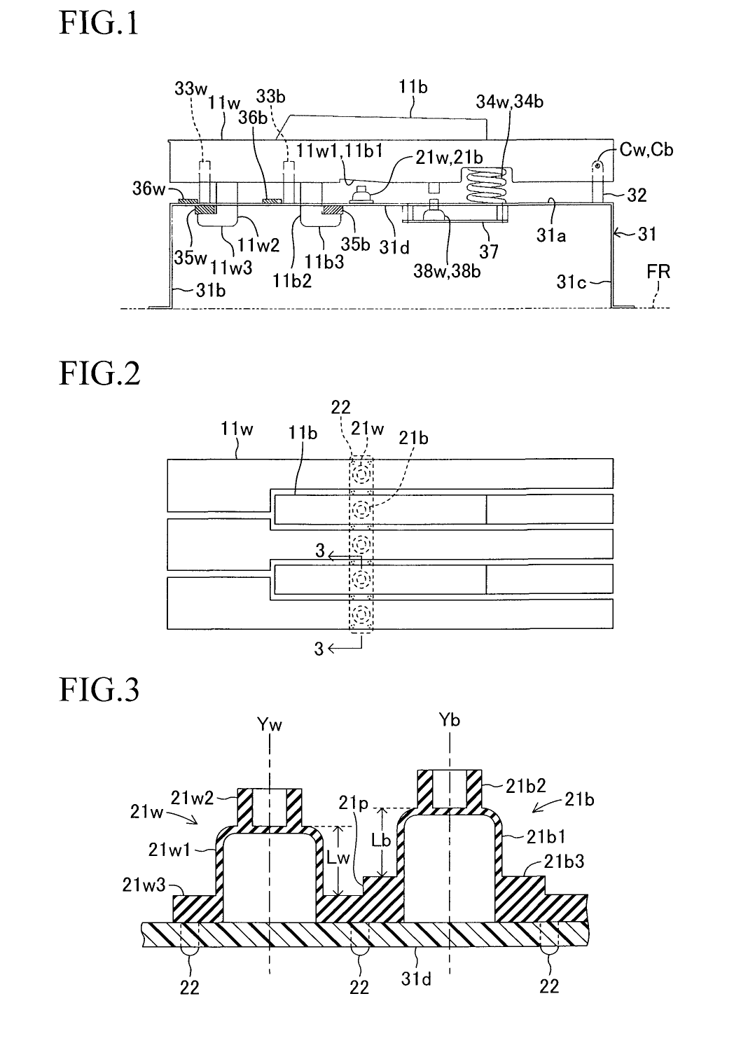

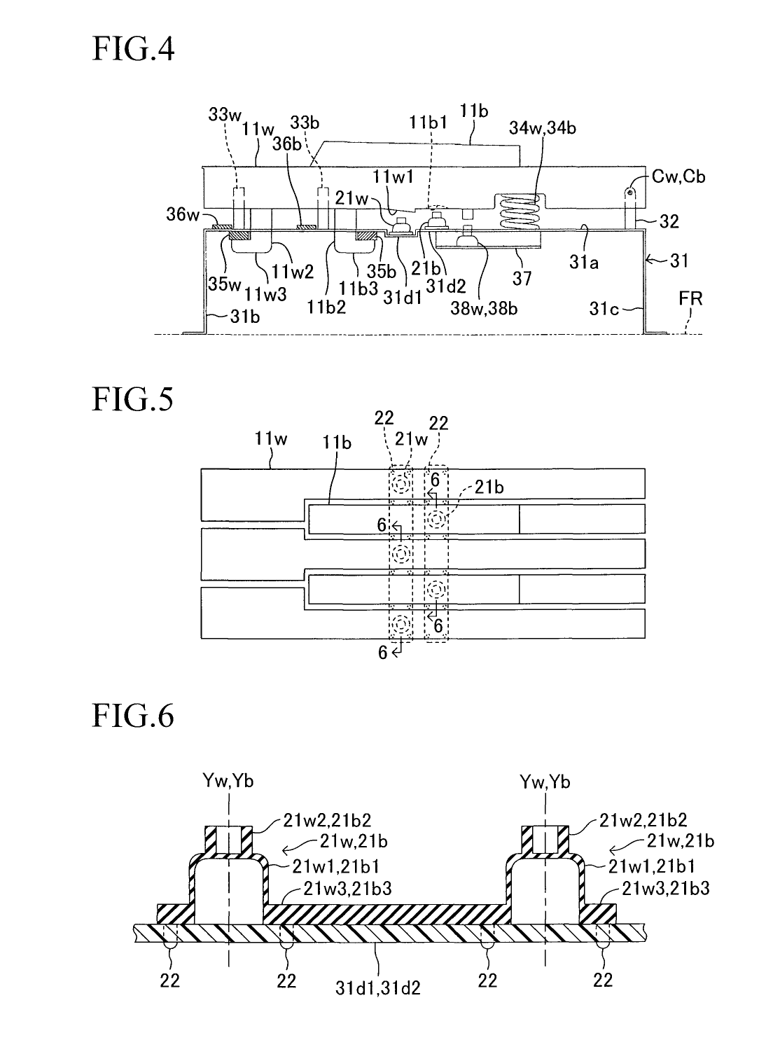

The first embodiment of the present invention will now be described with reference to the drawings. FIG. 1 is a schematic side view indicative of a keyboard apparatus according to the first embodiment seen from the right. FIG. 2 is a schematic top view of the keyboard apparatus. In schematic side views of the keyboard apparatus shown in FIG. 1 and FIGS. 4, 7, 11 and 15 which will be described later, the front-rear direction of the keyboard apparatus is defined as the lateral direction, and the vertical direction of the keyboard apparatus is defined as the vertical direction.

The keyboard apparatus has a plurality of white keys 11w and a plurality of black keys 11b which are to be depressed and released by a player. The keyboard apparatus also has a plurality of reaction force generation members 21w, 21b each exerting a reaction force against a player's depression of its corresponding key. The white key 11w is long in the front-rear direction, has a U-shaped cross-section which is open downward, and is located on a flat upper plate portion 31a of a key frame 31. The key frame 31 has flat leg portions 31b and 31c extending downward at the front end and the rear end of the upper plate portion 31a, with respective lower end portions of the leg portions 31b and 31c being fastened to a frame FR provided within a musical instrument. To the upper surface of the rear end portion of the upper plate portion 31a of the key frame 31, a pair of plate-like key supporting portions 32 erected to be opposed with each other inside the white key 11w is fastened. On the upper portion of each key supporting portion 32, a projecting portion jutting outward is provided to face each other. The projecting portion of each key supporting portion 32 is inserted into a through-hole provided on the both sides of the rear end portion of the white key 11w from inside the white key 11w so that the key can rotate. By such a configuration, the white key 11w is supported by the pair of key supporting portions 32 so that the white key 11w can pivot to allow the front end of the white key 11w to move in the vertical direction. Hereafter, the center of the pivoting of the white key 11w will be referred to as a pivot axis Cw. The black keys 11b are configured similarly to the white keys 11w, except that the black keys 11b are configured to have a raised upper face of the front portion. Each of the black keys 11b is also supported by the key supporting portions 32 so that the black key 11b can pivot about a pivot axis Cb to allow the front end of the black key 11b to move in the vertical direction. In this embodiment, the pivot axis Cb of the black key 11b is situated at the same position in the front-rear direction and in the vertical direction as the pivot axis Cw of the white key 11w.

On the upper surface of the upper plate portion 31a of the key frame 31, a key guide 33w is erected to be situated under the front end portion of the white key 11w, while a key guide 33b is erected to be situated under the front end portion of the black key 11b. The key guides 33w and 33b are inserted into the white key 11w and the black key 11b, respectively, so that the key guides 33w and 33b can slide in order to prevent the white key 11w and the black key 11b from moving in the lateral direction when the keys 11w and 11b pivot in the vertical direction.

A reaction force generation member 21w is provided for each of the white keys 11w, while a reaction force generation member 21b is provided for each of the black keys 11b. The reaction force generation members 21w and 21b are fastened to the upper surface of the upper plate portion 31a of the key frame 31 such that the reaction force generation member 21w and 21b are situated below a central portion of the white key 11w and the black key 11b, respectively, in the front-rear direction. In this case, the reaction force generation member 21w of the white key 11w is located on the same position in the front-rear direction as the reaction force generation member 21b of the black key 11b, so that the reaction force generation members 21w and 21b are arranged in a row in the lateral direction of the keyboard. Furthermore, the reaction force generation members 21w and 21b are integrally formed in one piece.

Hereafter, the reaction force generation members 21w and 21b will be explained. FIG. 3 is an enlarged cross-sectional view of the reaction force generation members seen along a line 3-3 of FIG. 2. The plurality of reaction force generation members 21w and 21b are integrally formed of elastic rubber. The reaction force generation members 21w and 21b have dome portions 21w1 and 21b1, top portions 21w2 and 21b2, and base portions 21w3 and 21b3, respectively. The dome portions 21w1 and 21b1 are point-symmetric about axis lines Yw and Yb, respectively, to be shaped like a dome (a bowl) which is thin and deformable by depression from above. Conversely, the axis lines Yw and Yb are central axes of the dome portions 21w1 and 21b1, and the top portions 21w2 and 21b2, respectively. Furthermore, the axis lines Yw and Yb are lines of action of force, the lines each passing through the starting point of the reaction force vector to extend in a vector direction. More specifically, the dome portions 21w1 and 21b1 are elastically deformed by an increasing depression from above to gradually increase a reaction force. After the reaction force has reached its peak, however, the dome portions 21w1 and 21b1 buckle to sharply decrease the reaction force to gradually increase the reaction force. The dome portion 21w1 and the dome portion 21b1 have the same shape. Particularly, a distance Lw ranging from the lower end surface to the upper end surface of the dome portion 21w1 is equal to a distance Lb ranging from the lower end surface to the upper end surface of the dome portion 21b1. The dome portions 21w1 and 21b1 are equivalent to body portions of the present invention, seen from a different viewpoint.

The top portions 21w2 and 21b2 are point-symmetric about the axis lines Yw and Yb, respectively, to be shaped like a cylinder. Furthermore, the top portions 21w2 and 21b2 are thick so that the top portions 21w2 and 21b2 are hardly deformed by depression from above. The top portions 21w2 and 21b2 are designed such that the undersurfaces of the top portions 21w2 and 21b2 are connected with the upper surfaces of the dome portions 21w1 and 21b1, respectively, while the top portions 21w2 and 21b2 have a uniform height at all circumferences to have a flat upper surface. At a circumferential part of the upper portion of the top portions 21w2 and 21b2, a notch (not shown) is provided so that air can escape between the inside and the outside of the top portions 21w2 and 21b2. The top portions 21w2 and 21b2 have the same shape.

The base portions 21w3 and 21b3 extend downward seamlessly from all circumferences of the lower end of the dome portions 21w1 and 21b1, respectively, to jut outward from the lower end surface of the dome portions 21w1 and 21b1, respectively. The base portions 21w3 and 21b3 are also thick so that the base portions 21w3 and 21b3 are hardly deformed by depression from above. The plurality of base portions 21w3 and 21b3 are seamlessly formed integrally with the neighboring base portions 21b3 and 21w3 such that the bottom surfaces of the base portions 21w3 and 21b3 form a flat surface. Although the upper surface of each of the base portions 21w3 and 21b3 is flat, a step 21p is provided between the upper surfaces of the base portions 21w3 and 21b3. Because of this step, the base portion 21w3 for the white key 11w is lower than the base portion 21b3 of the black key 11b.

On the undersurface of the base portions 21w3 and 21b3, a plurality of leg portions 22 jutting perpendicularly downward from the undersurface of the base portions 21w3 and 21b3 to be shaped like a cylinder are provided at proper positions. The plurality of leg portions 22 are also formed integrally with the dome portions 21w1 and 21b1, the top portions 21w2 and 21b2, and the base portions 21w3 and 21b3 by elastic body. The leg portions 22, which are provided in order to fasten the reaction force generation members 21w and 21b to a supporting portion 31d provided on the upper plate portion 31a of the key frame 31, are pressed into penetrating holes provided on the supporting portion 31d. Without using the leg portions 22, furthermore, the undersurface of the base portions 21w3 and 21b3 may be fastened to the upper plate portion 31a (the supporting portion 31d) of the key frame 31 with an adhesive or the like.

Furthermore, since the upper surface of the supporting portion 31d is a horizontal plane, the reaction force generation members 21w and 21b are fastened to the upper surface of the supporting portion 31d, with the axis lines Yw and Yb being kept parallel with each other and vertical with respect to the supporting portion 31d. As a result, by the difference in the height between the base portions 21w3 and 21b3 brought about by the step 21p, the upper surface of the top portion 21w2 of the reaction force generation member 21w is lower than the upper surface of the top portion 21b2 of the reaction force generation member 21b in the state where the reaction force generation members 21w and 21b are fastened to the upper surface of the supporting portion 31d. The difference in height is adjusted such that the amount of downward travel of the upper surface of the front end of the white key 11w by the depression of the white key 11w is roughly the same as the amount of downward travel of the upper surface of the front end of the black key 11b by the depression of the black key 11b at the start of deformation of the reaction force generation member 21w (the dome portion 21w1) and the reaction force generation member 21b (the dome portion 21b1), at respective peaks of the reaction forces of the reaction force generation members 21w and 21b, and at the end of the deformation of the reaction force generation members 21w and 21b.

On the undersurfaces of the white key 11w and the black key 11b, depression portions 11w1 and 11b1 for depressing the reaction force generation members 21w and 21b from above are provided, respectively, such that the depression portions 11w1 and 11b1 face the upper surfaces of the top portions 21w2 and 21b2 of the reaction force generation members 21w and 21b, respectively. Each of the depression portions 11w1 and 11b1 is shaped like a flat plate, and has an undersurface which is flat and is tilted such that the front side is high, and the rear side is low with respect to the undersurface of the white key 11w and the black key 11b. The tilting angle of the depression portions 11w1 and 11b1 is designed such that the normal lines of the undersurfaces of the depression portions 11w1 and 11b1 (straight lines perpendicular to the undersurfaces) become parallel to the axis lines Yw and Yb of the reaction force generation members 21w and 21b when the reaction forces of the reaction force generation members 21w and 21b reach their peaks, respectively. At the points in time when the reaction forces of the reaction force generation members 21w are 21b reach their peaks, respectively, furthermore, the directions in which the reaction forces act coincide with the directions of the axis lines Yw and Yb of the reaction force generation members 21w and 21b, respectively. Therefore, it can be understood that at the points in time when the reaction forces of the reaction force generation members 21w and 21b reach their peaks, respectively, the direction in which the reaction force acts is different between the white key 11w and the black key 11b, while the directions in which the reaction force generation members 21w and 21b are depressed at the points in time when the reaction forces of the reaction force generation members 21w and 21b reach their peaks coincide with the directions in which the reaction force generation members 21w and 21b exert a reaction force, respectively. In this case, the inclination of the undersurface of the depression portion 11b1 of the black key 11b against the horizontal surface (the undersurface of the black key 11b) is slightly greater than the inclination of the undersurface of the depression portion 11w1 of the white key 11w against the horizontal surface (the undersurface of the white key 11w). The respective undersurfaces of the depression portions 11w1 and 11b1 may not be flat but may be spherical as long as the normal lines of the undersurfaces including respective depression points of the depression portions 11w1 and 11b1 become parallel to the axis lines Yw and Yb, respectively, at the points in time when the reaction forces reach their peaks, respectively. Furthermore, the depression portions 11w1 and 11b1 may be a rib shaped like a cross, a letter H or the like protruding downward from the inner upper surface of the white key 11w and the black key 11b, respectively.

Furthermore, the keyboard apparatus has a spring 34w for the white key 11w and a spring 34b for the black key 11b. The springs 34w and 34b are provided between the white key 11w and the black key 11b, and the upper plate portion 31a of the key frame 31, respectively, such that the springs 34w and 34b are situated at the midpoint between the depression portions 11w1 and 11wb, and the key supporting portions 32, respectively. The springs 34w and 34b urge the white key 11w and the black key 11b upward, respectively, with respect to the upper plate portion 31a. The springs 34w and 34b may not be a coil, but may be a plate spring as long as the springs can urge the white key 11w and the black key 11b upward.

The white key 11w has an extending portion 11w2 which extends downward from the front end of the white key 11w. At the lower end of the extending portion 11w2, an engagement portion 11w3 jutting frontward is provided such that the engagement portion 11w3 is inserted below the upper plate portion 31a from above through a through-hole provided on the upper plate portion 31a of the key frame 31. On the undersurface of a front end portion of the upper plate portion 31a of the key frame 31, an upper limit stopper member 35w is provided. The upper limit stopper member 35w is a cushioning material such as felt. By coming into contact with the engagement portion 11w3 of the white key 11w, the upper limit stopper member 35w restricts upward displacement of the front end portion of the white key 11w. On the upper surface of the front end portion of the upper plate portion 31a of the key frame 31, a lower limit stopper member 36w is provided. The lower limit stopper member 36w is also a cushioning material such as felt. By coming into contact with the undersurface of the front end portion of the white key 11w, the lower limit stopper member 36w restricts downward displacement of the front end portion of the white key 11w.

The black key 11b has an extending portion 11b2 which extends downward from the front end of the black key 11b. At the lower end of the extending portion 11b2, an engagement portion 11b3 jutting rearward is provided such that the engagement portion 11b3 is inserted below the upper plate portion 31a from above through a through-hole provided on the upper plate portion 31a of the key frame 31. On the undersurface of a middle portion of the upper plate portion 31a of the key frame 31, an upper limit stopper member 35b is provided. The upper limit stopper member 35b is also a cushioning material such as felt. By coming into contact with the engagement portion 11b3 of the black key 11b, the upper limit stopper member 35b restricts upward displacement of the front end portion of the black key 11b. On the upper surface of the middle portion of the upper plate portion 31a of the key frame 31, a lower limit stopper member 36b is provided. The lower limit stopper member 36b is also a cushioning material such as felt. By coming into contact with the undersurface of the front end portion of the black key 11b, the lower limit stopper member 36b restricts downward displacement of the front end portion of the black key 11b.

To the undersurface of the upper plate portion 31a of the key frame 31, electric circuit boards 37 are fastened such that the electric circuit boards 37 are situated slightly behind the reaction force generation members 21w and 21b, respectively, to be parallel to the upper plate portion 31a. To the upper surface of the electric circuit boards 37, dome-shaped key switches 38w and 38b for the white key 11w and the black key 11b are fastened, respectively. The key switches 38w and 38b are changed from an off-state to an on-state by a depression of a jutting portion jutting from the undersurface of the white key 11w and the black key 11b at the time of a depression of a key to detect a user's depression/release of the white key 11w and the black key 11b. The detection of the depression/release of a key by the key switch 38w and 38b is used for control of generation of a musical tone signal.

Next, the operation of the keyboard apparatus according to the first embodiment configured as above will be explained. When a player starts depressing the white key 11w or the black key 11b, the depressed white key 11w or black key 11b starts pivoting about the pivot axis Cw or Cb, resisting a reaction force exerted by the spring 34w or 34b, so that the front end portion of the white key 11w or the black key 11b moves downward to allow the engagement portion 11w3 or 11b3 to be released from the upper limit stopper member 35w or 35b to allow the depression portion 11w1 or 11b1 to come into contact with the rear end of the upper surface of the top portion 21w2 or 21b2 of the reaction force generation member 21w or 21b. If the depressed white key 11w or black key 11b is depressed further, the front end portion of the white key 11w or the black key 11b moves downward, so that the dome portion 21w1 or 21b1 of the reaction force generation member 21w or 21b starts being deformed by the depression by the depression portion 11w1 or 11b1. As a result, the player starts recognizing not only the reaction force exerted by the spring 34w or 34b but also the gradually increasing reaction force exerted by the reaction force generation member 21w or 21b.

If the depressed white key 11w or black key 11b is depressed further, the reaction force of the reaction force generation member 21w or 21b reaches its peak, so that the dome portion 21w1 or 21b1 starts buckling and deforming. As a result, the player can recognize a clear feeling of click. Slightly later than the buckling, furthermore, the key switch 38w or 38b turns from the off-state to the on-state by a depression of the jutting portion jutting from the undersurface of the white key 11w or the black key 11b. In response to the change to the on-state of the key switch 38w or 38b, a musical tone signal generation circuit which is not shown starts generating a musical tone signal.

If the depressed white key 11w or black key 11b is depressed further, the undersurface of the front end portion of the white key 11w or the black key 11b comes into contact with the lower limit stopper member 36w or 36b to stop the pivoting of the white key 11w or the black key 11b. In this state, the elastic deformation of the reaction force generation member 21w or 21b also stops. If the white key 11w or the black key 11b is released, the front end portion of the white key 11w or the black key 11b moves upward because of the reaction forces of the reaction force generation member 21w or 21b and the spring 34w or 34b. In the course during which the front end portion of the white key 11w or the black key 11b moves to return upward, the key switch 38w or 38b changes from the on-state to the off-state, so that the musical tone signal generation circuit which is not shown controls the termination of the generation of the musical tone signal. If the front end portion of the white key 11w or the black key 11b moves upward, furthermore, the engagement portion 11w3 or 11b3 comes into contact with the upper limit stopper member 35w or 35b to allow the white key 11w or the black key 11b to return to the key-release state.

The keyboard apparatus configured to operate as above is designed such that because of the difference in thickness between the base portion 21w3 (the length in the direction of the axis line Yw) and the base portion 21b3 (the length in the direction of the axis line Yb), the amount of downward travel of the upper surface of the front end of the white key 11w by the depression of the white key 11w is roughly the same as the amount of downward travel of the upper surface of the front end of the black key 11b by the depression of the black key 11b at the start of deformation of the reaction force generation member 21w (the dome portion 21w1) and the reaction force generation member 21b (the dome portion 21b1), at respective peaks of the reaction forces of the reaction force generation members 21w and 21b, and at the end of the deformation of the reaction force generation members 21w and 21b. In spite of the difference in structure between the white key 11w and the black key 11b, as a result, a player of the keyboard apparatus can operate both the white key 11w and the black key 11b without any feeling of strangeness.

The keyboard apparatus is also designed such that the dome portion 21w1 and the top portion 21w2 have the same shape and size as the dome portion 21b1 and the top portion 21b2, respectively, although the height of the lower end surface of the dome portion is different between the dome portion 21w1 and the dome portion 21b1 because of the difference in height between the base portion 21w3 and the base portion 21b3. As a result, the keyboard apparatus can provide the player with almost the same key touch on both the white key 11w and the black key 11b. In the first embodiment, furthermore, the plurality of reaction force generation members 21w and the plurality of reaction force generation members 21b are formed integrally in one piece so that the integrally formed reaction force generation members 21w and 21b can be assembled easily.

In the above explanation, the difference in height of the lower end surface of the dome portion between the dome portion 21w1 of the white key 11w and the dome portion 21b1 of the black key 11b was explained with reference to the upper surface of the supporting portion 31d. Instead of the above explanation, however, the difference will now be explained, using the points of intersection between the respective lower end surfaces of the dome portions 21w1 and 21b1, and the axis lines Yw and Yb. In the above case, the axis line Yw of the dome portion 21w1 of the reaction force generation member 21w of the white key 11w is parallel with the axis line Yb of the dome portion 21b1 of the reaction force generation member 21b of the black key 11b as indicated in FIG. 3 and FIG. 16(A). In this case, therefore, a difference ΔL in distance in the direction of the axis lines Yw and Yb between the respective lower end surfaces of the dome portions 21w1 and 21b1 can be defined as a distance in the direction of the axis lines Yw and Yb between an intersection point Pw between the lower end surface of the dome portion 21w1 and the axis line Yw, and an intersection point Pb between the lower end surface of the dome portion 21b1 and the axis line Yb. The difference ΔL in distance can be also defined as a difference in distance between the intersection point Pw between the lower end surface of the dome portion 21w1 and the axis line Yw, and an intersection point Pb′ between the lower end surface of the dome portion 21b1 and the axis line Yw, and can be also defined as a difference in distance between an intersection point Pw′ between the lower end surface of the dome portion 21w1 and the axis line Yb, and the intersection point Pb between the lower end surface of the dome portion 21b1 and the axis line Yb.

As indicated in FIG. 16(B), however, there are cases where the reaction force generation member 21b for the black key is assembled such that the reaction force generation member 21b for the black key is inclined against the reaction force generation member 21w for the white key. In such cases, since the axis lines Yw and Yb are not parallel with each other, it is difficult to define the difference in height of the lower end surface between the dome portions 21w1 and 21b1 by the above-described scheme. In this specification, therefore, the difference in position of the respective lower end surfaces of the dome portions 21w1 and 21b1 will be defined by use of either of the axis line Yw of the dome portion 21w1 or the axis line Yb of the dome portion 21b1, including the case where the axis lines Yw and Yb are parallel with each other. More specifically, a distance in the direction of the axis line Yw between the intersection point Pw between the lower end surface of the dome portion 21w1 and the axis line Yw, and the intersection point Pb′ between the lower end surface of the dome portion 21b1 and the axis line Yw will be defined. Alternatively, a distance in the direction of the axis line Yb between the intersection point Pb between the lower end surface of the dome portion 21b1 and the axis line Yb, and the intersection point Pw′ between the lower end surface of the dome portion 21w1 and the axis line Yb will be defined. In this case as well, furthermore, since the inclination of the axis line Yb against the axis line Yw is exaggerated in FIG. 16(B), there substantially exists a distance in the direction of the axis line Yw (or the axis line Yb) between the lower end surface of the dome portion 21w1 and the lower end surface of the dome portion 21b1 as in the case of FIG. 16(A). The respective lower end surfaces of the dome portions 21w1 and 21b1 are positioned similarly in embodiments which will be described later.

The above-described first embodiment is designed such that the dome portion 21w1 and the top portion 21w2 have exactly the same shape and size as the dome portion 21b1 and the top portion 21b2, respectively, but may have a slightly different shape, as in the case of the above-described inclination.

Furthermore, the first embodiment is configured such that the reaction force generation members 21w and 21b are fastened to the supporting portion 31d so that the reaction force generation members 21w and 21b can be depressed by the depression portions 11w1 and 11b1 of the white key 11w and the black key 11b, respectively. Instead of this configuration, however, the reaction force generation members 21w and 21b may be fastened to the white key 11w and the black key 11b, respectively, with depression portions being provided on the upper plate portion 31a of the key frame 31 to be opposed to the reaction force generation members 21w and 21b, respectively, so that the reaction force generation members 21w and 21b can be depressed by the depression portions by the pivoting white key 11w and the pivoting black key 11b, respectively. In this modification, it is necessary to form each of the reaction force generation members 21w and 21b separately to be individually fastened to the white key 11w and the black key 11b.

### b. Second Embodiment

Next, a keyboard apparatus according to the second embodiment in which the plurality of reaction force generation members 21w of the white keys 11w and the plurality of reaction force generation members 21b of the black keys 11b are arranged in two rows such that the reaction force generation members 21w are displaced in the front-rear direction from the reaction force generation members 21b will be explained. FIG. 4 is a schematic side view of the keyboard apparatus according to the second embodiment seen from the right. FIG. 5 is a schematic top view of the keyboard apparatus. FIG. 6 is an enlarged cross-sectional view indicating the reaction force generation member 21w of the white key 11w and the reaction force generation member 21b of the black key 11b seen along lines 6-6 shown in FIG. 5.

The plurality of reaction force generation members 21w are arranged in the lateral direction on a supporting portion 31d1 provided on the upper plate portion 31a of the key frame 31. The supporting portion 31d1 extends in the lateral direction such that the supporting portion 31d1 is slightly lower than the upper plate portion 31a. The plurality of reaction force generation members 21w are formed integrally by elastic body in one piece, with each of the reaction force generation members 21w having the dome portion 21w1, the top portion 21w2 and the base portion 21w3 which are similar to those of the first embodiment. The plurality of dome portions 21w1 and top portions 21w2 are situated below the depression portions 11w1 of the white keys 11w. The base portions 21w3 are configured to have the same thickness to be shaped like a flat plate to be connected with the dome portions 21w1.

The plurality of reaction force generation members 21b are arranged in the lateral direction on a supporting portion 31d2 provided on the upper plate portion 31a of the key frame 31. The supporting portion 31d2 extends in the lateral direction such that the supporting portion 31d2 is situated behind the supporting portion 31d1, and is as high as the upper plate portion 31a. The plurality of reaction force generation members 21b are also formed integrally by elastic body in one piece, with each of the reaction force generation members 21b having the dome portion 21b1, the top portion 21b2 and the base portion 21b3 which are similar to those of the first embodiment. The plurality of dome portions 21b1 and top portions 21b2 are situated below the depression portions 11b1 of the black keys 11b. The depression portions 11b1 of the black keys 11b are situated behind the depression portions 11w1 of the white keys 11w. The base portions 21b3 are configured to have the same thickness to be shaped like a flat plate to be connected with the dome portions 21b1. In this case, the reaction force generation members 21w of the white keys 11w are provided separately from the reaction force generation members 21b of the black keys 11b, but have the same shape as the reaction force generation members 21b of the black keys 11b. Particularly, the base portions 21w3 and 21b3 have the same thickness, and the dome portion 21w1 and the top portion 21w2 have the same shapes as the dome portion 21b1 and the top portion 21b2, respectively.

In the second embodiment, furthermore, because of the difference in vertical position between the supporting portions 31d1 and 31d2, the upper surface of the top portion 21w2 of the reaction force generation member 21w is lower than the upper surface of the top portion 21b2 of the reaction force generation member 21b. The difference in vertical position is adjusted, similarly to the first embodiment, such that the amount of downward travel of the upper surface of the front end of the white key 11w by the depression of the white key 11w is roughly the same as the amount of downward travel of the upper surface of the front end of the black key 11b by the depression of the black key 11b at the start of deformation of the reaction force generation member 21w (the dome portion 21w1) and the reaction force generation member 21b (the dome portion 21b1), at respective peaks of the reaction forces of the reaction forces of the reaction force generation members 21w and 21b, and at the end of the deformation of the reaction force generation members 21w and 21b. Since the other configuration of the second embodiment is similar to the first embodiment, components of the second embodiment are given the same numerals as those of the first embodiment to omit their explanations.

In response to the player's depression and release of the white key 11w and the black key 11b, the keyboard apparatus according to the second embodiment configured as above also operates similarly to the first embodiment. Furthermore, the second embodiment is configured such that because of the difference in vertical position between the supporting portion 31d1 and the supporting portion 31d2, the player of the keyboard apparatus of the second embodiment can depress and release both the white key 11w and the black key 11b without any feeling of strangeness, and can perceive roughly the same key touch on the white keys 11w and the black keys 11b in spite of the difference in structure between the white key 11w and the black key 11b, because of the reason similar to that of the first embodiment. In the second embodiment, furthermore, the plurality of reaction force generation members 21w are formed integrally in one piece, while the plurality of reaction force generation members 21b are also formed integrally in one piece. Therefore, the integrally formed reaction force generation members 21w and 21b can be assembled easily.

The above-described second embodiment is also designed such that the dome portion 21w1 and the top portion 21w2 have exactly the same shape and size as the dome portion 21b1 and the top portion 21b2, respectively, but may have a slightly different shape, as in the case of the first embodiment.

Furthermore, the second embodiment is also configured such that the reaction force generation members 21w and 21b are fastened to the supporting portions 31d1 and 31d2, respectively, so that the reaction force generation members 21w and 21b can be depressed by the depression portions 11w1 and 11b1 of the white key 11w and the black key 11b, respectively. Instead of this configuration, however, the reaction force generation members 21w and 21b may be fastened to the white key 11w and the black key 11b, respectively, with depression portions being provided on the upper plate portion 31a of the key frame 31 to be opposed to the reaction force generation members 21w and 21b, respectively, so that the reaction force generation members 21w and 21b can be depressed by the depression portions by the pivoting white key 11w and the pivoting black key 11b, respectively. In this modification as well, it is necessary to form each of the reaction force generation members 21w and 21b separately to be individually fastened to the white key 11w and the black key 11b.

### c. Third Embodiment

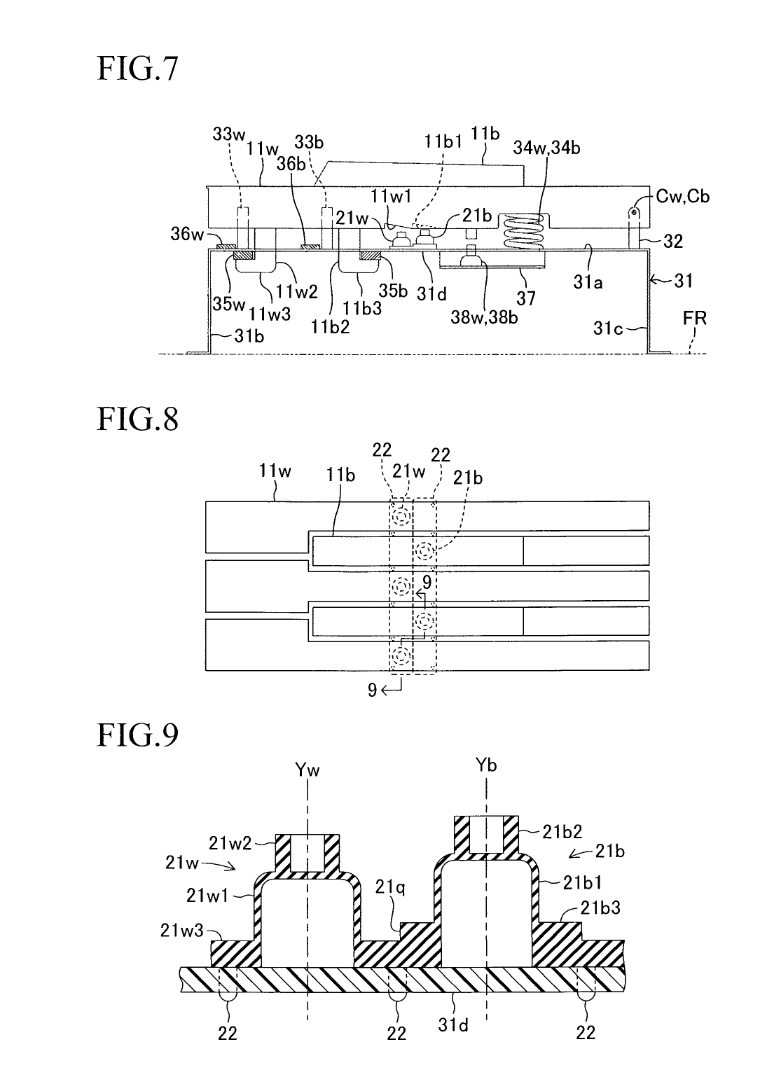

Next, a keyboard apparatus according to the third embodiment in which the plurality of reaction force generation members 21w of the white keys 11w and the plurality of reaction force generation members 21b of the black keys 11b of the above second embodiment are integrally formed in one piece will be explained. FIG. 7 is a schematic side view of the keyboard apparatus according to the third embodiment seen from the right. FIG. 8 is a schematic top view of the keyboard apparatus. FIG. 9 is an enlarged cross-sectional view indicating the reaction force generation members 21w and 21b of the white key 11w and the black key 11b seen along a line 9-9 shown in FIG. 8.

The third embodiment is configured such that the plurality of reaction force generation members 21w and the plurality of reaction force generation members 21b of the above second embodiment are formed integrally in one piece, while the reaction force generation members 21w and 21b have the dome portions 21w1 and 21b1, the top portions 21w2 and 21b2, and the base portions 21w3 and 21b3 which are similar to those of the first and second embodiments, respectively. In this embodiment, respective undersurfaces of the plurality of base portions 21w3 and 21b3 form a seamless horizontal plane to have a step 21q between an upper surface of the seamless base portions 21w3 and an upper surface of the seamless base portions 21b3. The integrally formed reaction force generation members 21w and 21b are provided on the supporting portion 31d provided on the upper plate portion 31a. Because of such a configuration, the upper surface of the top portion 21w2 of the reaction force generation member 21w is lower than the upper surface of the top portion 21b2 of the reaction force generation member 21b. The difference in vertical position is adjusted, similarly to the first and second embodiments, such that the amount of downward travel of the upper surface of the front end of the white key 11w by the depression of the white key 11w is roughly the same as the amount of downward travel of the upper surface of the front end of the black key 11b by the depression of the black key 11b at the start of deformation of the reaction force generation member 21w (the dome portion 21w1) and the reaction force generation member 21b (the dome portion 21b1), at respective peaks of the reaction forces of the reaction force generation members 21w and 21b, and at the end of the deformation of the reaction force generation members 21w and 21b. Since the other configuration of the third embodiment is similar to the first embodiment, components of the third embodiment are given the same numerals as those of the first embodiment to omit their explanations.

In response to the player's depression and release of the white key 11w and the black key 11b, the keyboard apparatus according to the third embodiment configured as above also operates similarly to the first and second embodiments. Furthermore, the third embodiment is configured such that because of the difference in thickness of the base portion, that is, in length of the base portion in the direction of the axis lines Yw and Yb between the base portion 21w3 of the white key 11w and the base portion 21b3 of the black key 11b, the player of the keyboard apparatus of the third embodiment can depress and release both the white key 11w and the black key 11b without any feeling of strangeness, and can perceive roughly the same key touch on the white keys 11w and the black keys 11b in spite of the difference in structure between the white key 11w and the black key 11b because of the reason similar to that of the first and second embodiments. In the third embodiment, furthermore, the plurality of reaction force generation members 21w and the plurality of reaction force generation members 21b are formed integrally in one piece, so that the integrally formed reaction force generation members 21w and 21b can be assembled easily.

The above-described third embodiment is also designed such that the dome portion 21w1 and the top portion 21w2 have exactly the same shape and size as the dome portion 21b1 and the top portion 21b2, respectively, but may have a slightly different shape, as in the case of the first and second embodiments.

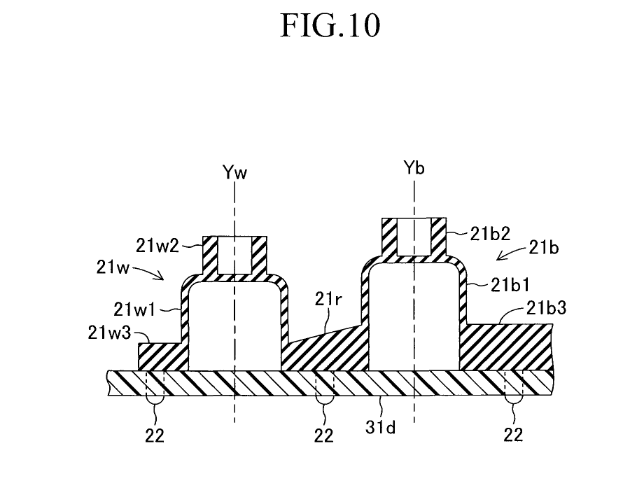

The third embodiment is designed such that the step 21q is provided between the base portions 21w3 and the base portions 21b3. Instead of the step 21q, however, a slanting surface 21r may be provided to connect the base portions 21w3 with the base portions 21b3 to make a difference in vertical position of the lower end surface between the dome portions 21w1 and the dome portions 21b1 as indicated in FIG. 10. Further, this modification can be applied to the above first embodiment in which the reaction force generation members 21w and 21b are arranged in a row in the lateral direction of the keyboard. In other words, regarding the reaction force generation members 21w and 21b shown in FIG. 3, instead of the step 21p, a slanting surface may be provided to connect the base portions 21w3 with the base portions 21b3 to make a difference in vertical position of the lower end surface between the dome portions 21w1 and the dome portions 21b1.

Furthermore, the third embodiment and its modification are designed such that the rear end of the dome portion 21w1 of the white key 11w (the right end of the dome portion 21w1 in FIG. 8) is situated in front of (on the left side in FIG. 8) the front end of the dome portion 21b1 of the black key 11b (the left end of the dome portion 21b1 in FIG. 8). However, the third embodiment and its modification may be modified such that the rear end of the dome portion 21w1 of the white key 11w is situated in between the front end and the rear end of the dome portion 21b1 of the black key 11b. In other words, the dome portion 21w1 may be situated in front of the dome portion 21b1, with a part of the dome portion 21w1 overlapping with the dome portion 21b1 in the front-rear direction.

### d. Fourth Embodiment

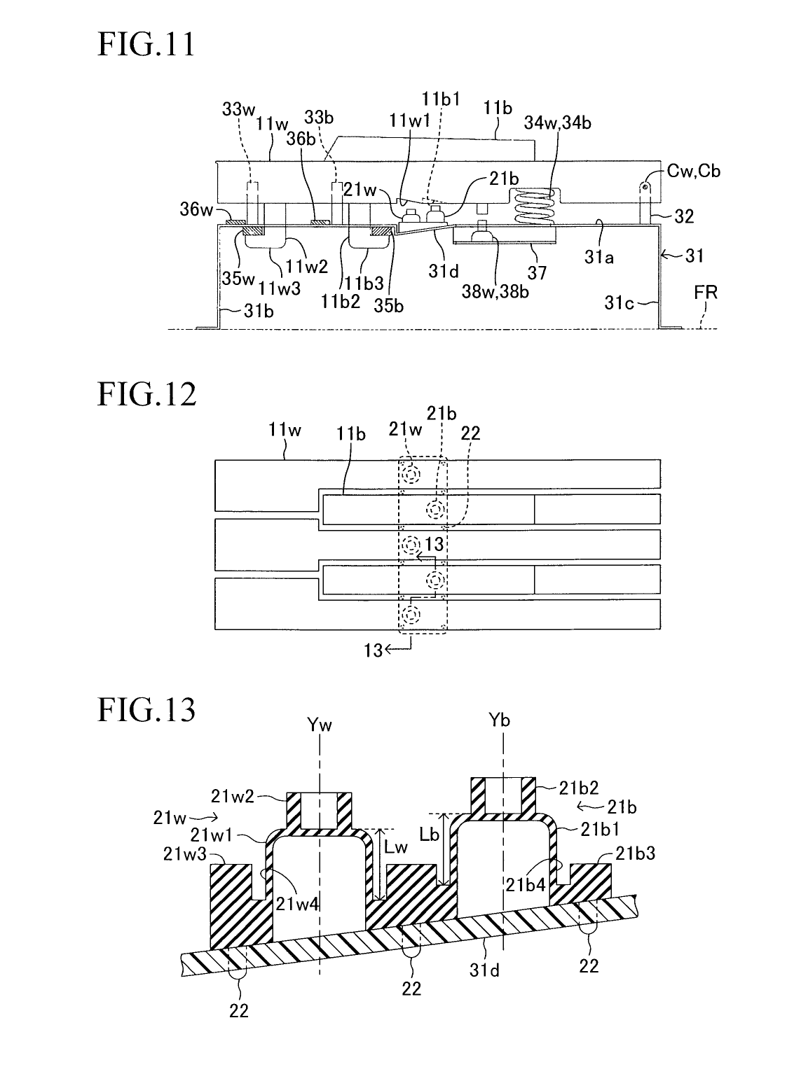

Next, a keyboard apparatus according to the fourth embodiment in which respective bottom surfaces of the base portions 21w3 and 21b3 of the reaction force generation members 21w and 21b are inclined, with the supporting portion 31d provided on the upper plate portion 31a of the key frame 31 being also inclined will be explained. FIG. 11 is a schematic side view of the keyboard apparatus according to the fourth embodiment seen from the right. FIG. 12 is a schematic top view of the keyboard apparatus. FIG. 13 is an enlarged cross-sectional view indicating the reaction force generation members 21w and 21b of the white key 11w and the black key 11b seen along a line 13-13 shown in FIG. 12.

The fourth embodiment is configured such that the supporting portion 31d is inclined such that the front side of the supporting portion 31d is lower than the rear side, while the supporting portion 31d is formed integrally with the upper plate portion 31a. In the fourth embodiment, similarly to the second and third embodiments, the depression portions 11w1 of the white key 11w are located on the front side, with the depression portions 11b1 of the black key 11b being located on the rear side, so that the depression portions 11w1 and the depression portions 11b1 form two rows. More specifically, each of the depression portions 11w and 11b1 is configured such that the front side of the depression portion is higher than the rear side to be a flat surface.

The plurality of reaction force generation members 21w and the plurality of reaction force generation members 21b are formed integrally in one piece, while the reaction force generation members 21w and 21b have the dome portions 21w1 and 21b1, the top portions 21w2 and 21b2, and the base portions 21w3 and 21b3 which are similar to those of the first to third embodiments, respectively. In this embodiment, respective undersurfaces of the plurality of base portions 21w3 and 21b3 form a seamless slanting plane, while respective upper surfaces of the base portions 21w3 and 21b3 are horizontal and flat. At the outside of the outer periphery of the dome portion 21w1, a cylindrical gap 21w4 provided by notching the base portion 21w3 is provided, while a cylindrical gap 21b4 provided by notching the base portion 21b3 is provided at the outside of the outer periphery of the dome portion 21b1. The width in a radial direction of the gaps 21w4 and 21b4 is set to be within an extent which prevents the outer periphery of the dome portions 21w1 and 21b1 from coming into contact with the inner surface of the gaps 21w4 and 21b4 when the dome portions 21w1 and 21b1 are deformed by the top portions 21w2 and 21b2 depressed from above, respectively.

In this embodiment, the height of the dome portions 21w1 and 21b1 indicates the height measured from the bottom surface of the gaps 21w4 and 21b4 to the upper surface of the dome portions 21w1 and 21b1, respectively. Furthermore, the fourth embodiment is designed such that by making the depth of the gap 21w4 deeper than the gap 21b4, the height of the dome portion 21w1 and the top portion 21w2 is lower than the height of the dome portion 21b1 and the top portion 21b2. The dome portion 21w1 and the top portion 21w2 have the same shape as the dome portion 21b1 and the top portion 21b2, so that a distance Lw between the lower end surface to the upper end surface of the dome portion 21w1 is equal with a distance Lb between the lower end surface to the upper end surface of the dome portion 21b1. The difference in height between the dome portions 21w1 and 21b1 is adjusted, similarly to the first to third embodiments, such that the amount of downward travel of the upper surface of the front end of the white key 11w by the depression of the white key 11w is roughly the same as the amount of downward travel of the upper surface of the front end of the black key 11b by the depression of the black key 11b at the start of deformation of the reaction force generation member 21w (the dome portion 21w1) and the reaction force generation member 21b (the dome portion 21b1), at respective peaks of the reaction forces of the reaction force generation members 21w and 21b, and at the end of the deformation of the reaction force generation members 21w and 21b. Since the other configuration of the fourth embodiment is similar to the first to third embodiments, components of the fourth embodiment are given the same numerals as those of the first to third embodiments to omit their explanations.

In response to the player's depression and release of the white key 11w and the black key 11b, the keyboard apparatus according to the fourth embodiment configured as above also operates similarly to the first to third embodiments. Furthermore, the fourth embodiment is configured such that because of the difference in depth of the gap between the gap 21w4 and the gap 21b4, the player of the keyboard apparatus of the fourth embodiment can depress and release both the white key 11w and the black key 11b without any feeling of strangeness, and can perceive roughly the same key touch on the white keys 11w and the black keys 11b in spite of the difference in structure between the white key 11w and the black key 11b because of the reason similar to that of the first to third embodiments. In the fourth embodiment, furthermore, the plurality of reaction force generation members 21w and the plurality of reaction force generation members 21b are formed integrally in one piece, with respective bottom surfaces of the base portions 21w3 and 21b3 being seamlessly inclined, so that the integrally formed reaction force generation members 21w and 21b can be easily provided on the inclined supporting portion 31d.

The above-described fourth embodiment is also designed such that the dome portion 21w1 and the top portion 21w2 have exactly the same shape and size as the dome portion 21b1 and the top portion 21b2, respectively, but may have a slightly different shape, as in the cases of the first to third embodiments.

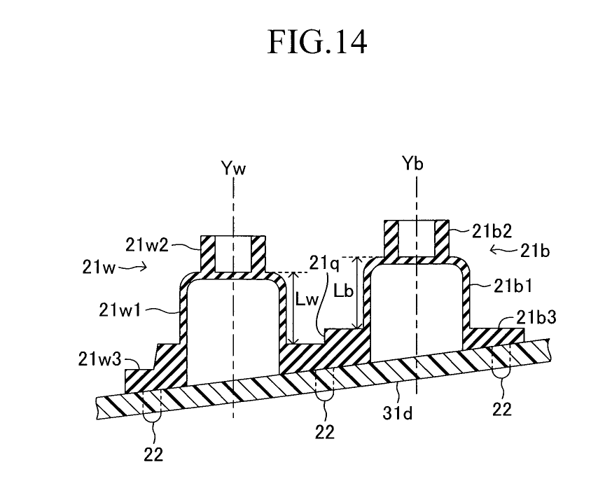

In the fourth embodiment, furthermore, the difference in depth between the gaps 21w4 and 21b4 makes a difference in height between the dome portion 21w1 and the top portion 21w2, and the dome portion 21b1 and the top portion 21b2. However, the fourth embodiment may be modified as indicated in FIG. 14 such that without the gaps 21w4 and 21b4, the step 21q is provided between the upper surface of the base portions 21w3 and the upper surface of the base portions 21b3, with the undersurface of the base portions 21w3 and 21b3 being inclined. By this modification as well, the dome portion 21w1 and the top portion 21w2 can have the same shape as the dome portion 21b1 and the top portion 21b2, with different height between the dome portion 21w1 and the top portion 21w2, and the dome portion 21b1 and the top portion 21b2. Instead of the step 21q, similarly to the modification of the third embodiment, the slanting surface 21r may be provided to connect the base portions 21w3 with the base portions 21b3 to make a difference in the vertical position of the lower end surface between the dome portion 21w1 and the dome portion 21b1 (see FIG. 10).

Furthermore, the fourth embodiment and its modifications are designed such that the rear end of the dome portion 21w1 of the white key 11w (the right end of the dome portion 21w1 in FIG. 12) is situated in front of (on the left side in FIG. 12) the front end of the dome portion 21b1 of the black key 11b (the left end of the dome portion 21b1 in FIG. 12). However, the fourth embodiment and its modifications may also be modified such that the rear end of the dome portion 21w1 of the white key 11w is situated in between the front end and the rear end of the dome portion 21b1 of the black key 11b. In other words, the dome portion 21w1 may be situated in front of the dome portion 21b1, with a part of the dome portion 21w1 overlapping with the dome portion 21b1 in the front-rear direction.

### e. Fifth Embodiment

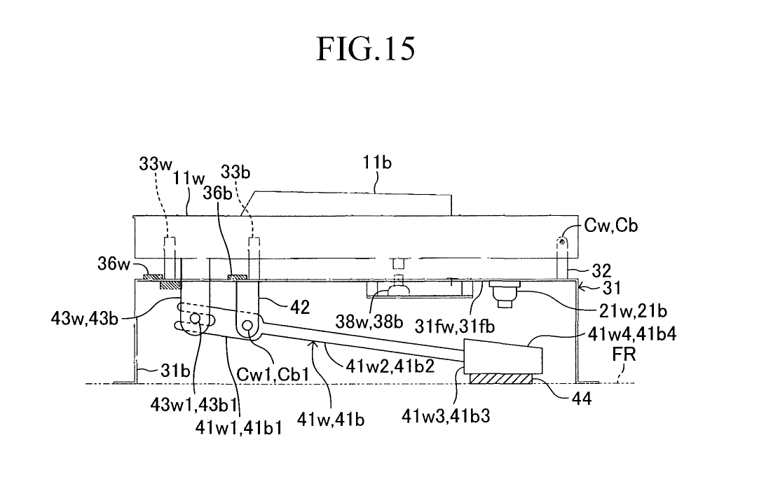

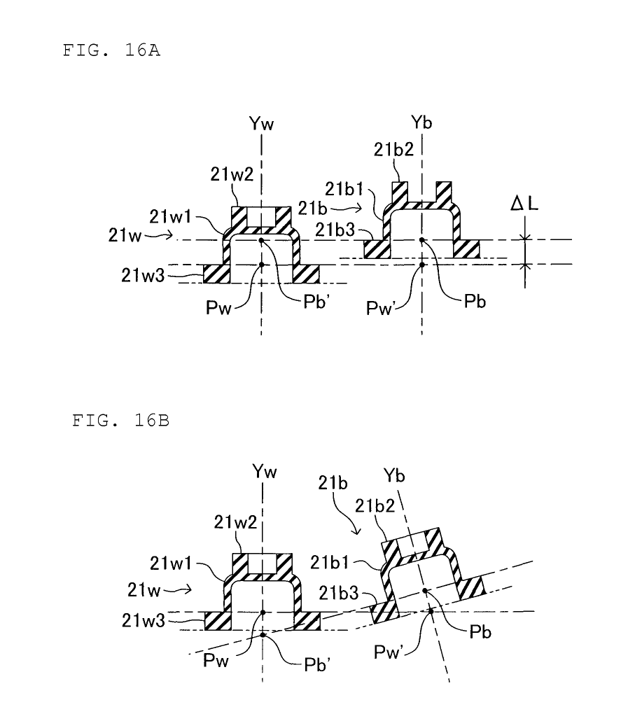

Next, the fifth embodiment in which pivoting bodies which pivot in conjunction with pivoting of the white key 11w and the black key 11b depress the reaction force generation members 21w and 21b will be explained. FIG. 15 indicates a keyboard apparatus according to the fifth embodiment. The keyboard apparatus has hammers 41w and 41b which are the above-described pivoting bodies such that the hammers 41w and 41b correspond to the white key 11w and the black key 11b, respectively.

The hammers 41w and 41b are supported by hammer supporting members 42 provided for the respective white key 11w and black key 11b so that the hammers 41w and 41b can pivot. Each of the hammer supporting members 42 extends downward from the undersurface of the upper plate portion 31a such that the hammer supporting member 42 is situated at the middle of the white key 11w and the black key 11b in the front-rear direction. The hammers 41w and 41b are formed of base portions 41w1 and 41b1, connecting rods 41w2 and 41b2, and mass bodies 41w3 and 41b3, respectively. The base portions 41w1 and 41b1 are supported at the middle portion thereof by the hammer supporting members 42 so that the hammers 41w and 41b can pivot about pivot axes Cw1 and Cb1, respectively. More specifically, the mass bodies 41w3 and 41b3 pivot up and down. Each of the base portions 41w1 and 41b1 has bifurcated legs at the front portion. Between the legs, drive shafts 43w1 and 43b1 provided on extending portions 43w and 43b extending vertically from the undersurface of the white key 11w and the black key 11b penetrate so that the drive shafts 43w1 and 43b1 can slide, respectively. The extending portions 43w and 43b penetrate through a through-hole provided on the upper plate portion 31a so that the extending portions 43w and 43b can be displaced up and down. As a result, the respective front ends of the base portions 41w1 and 41b1 are to be displaced downward when the white key 11w and the black key 11b are depressed. The connecting rods 41w2 and 41b2 extend in the front-rear direction to connect the base portions 41w1 and 41b1 with the mass bodies 41w3 and 41b3, respectively. The mass bodies 41w3 and 41b3 urge the respective front ends of the hammers 41w and 41b upward, using the mass of the mass bodies 41w3 and 41b3, respectively.

Below each of the mass bodies 41w3 and 41b3, an upper limit stopper member 44 for preventing the mass bodies 41w3 and 41b3 from moving downward is fastened to the frame FR. The upper limit stopper member 44 is also made of a cushioning material such as felt. In the key-release state, therefore, the mass bodies 41w3 and 41b3 are situated on the upper limit stopper member 44 in order to restrict upward move of the front end of the white key 11w and the black key 11b. Therefore, the keyboard apparatus of the fifth embodiment does not have the upper limit stopper members 35w and 35b, and the extending portions 11w2 and 11b2 provided for the first embodiment.

The reaction force generation members 21w and 21b are fastened to the respective undersurfaces of supporting portions 31fw and 31fb provided on the upper plate portion 31a such that the reaction force generation members 21w and 21b are opposed to the mass bodies 41w3 and 41b3, respectively. The respective upper surfaces of the mass bodies 41w3 and 41b3 serve as flat depression portion 41w4 and 41b4, respectively, to face the undersurfaces (equivalent to the upper surfaces of the first to fourth embodiments) of the top portions 21w2 and 21b2 of the reaction force generation members 21w and 21b in the key-release state. When the keys are depressed, the depression portions 41w4 and 41b4 move upward to come into contact with the undersurface of the top portions 21w2 and 21b2 to depress the reaction force generation members 21w and 21b, respectively. In this case as well, the reaction force generation members 21w and 21b are elastically deformed by the depression to buckle after the reaction forces reach their peaks, respectively. Furthermore, since the hammers 41w and 41b exert a reaction force against the depression of the white key 11w and the black key 11b, respectively, the keyboard apparatus of the fifth embodiment may have the springs 34w and 34b provided for the first embodiment, but does not have the springs 34w and 34b in the fifth embodiment.

In the fifth embodiment as well, the reaction force generation members 21w and 21b are configured such that because of the difference in the amount of vertical travel of the mass bodies 41w3 and 41b3 between the white key 11w and the black key 11b, the respective vertical positions of the dome portion 21w1 and the top portion 21w2 are different from the respective vertical positions of the dome portion 21b1 and the top portion 21b2, similarly to the first embodiment. The reaction force generation members 21w and 21b are configured and shaped similarly to those of the first embodiment. Since the other configuration of the fifth embodiment is similar to the first embodiment, components of the fifth embodiment are given the same numerals as those of the first embodiment to omit their explanations.

According to the fifth embodiment configured as above, when the white key 11w and the black key 11b are depressed, the drive shafts 43w1 and 43b1 of the extending portions 43w and 43b move downward, so that the hammers 41w and 41b pivot about the pivot axes Cw1 and Cb1 in the counterclockwise direction, respectively. Then, the depression portions 41w4 and 41b4 of the mass bodies 41w3 and 41b3 of the hammers 41w and 41b depress the reaction force generation members 21w and 21b, respectively, so that the reaction force generation members 21w and 21b elastically deform to buckle. If the white key 11w and the black key 11b are depressed further, the reaction force generation members 21w and 21b elastically deform further, so that the depressions of the white key 11w and the black key 11b are finished by the contact between the undersurface of the front end of the white key 11w and the black key 11b and the lower limit stopper members 36w and 36b. When the white key 11w and the black key 11b are depressed, the hammers 41w and 41b, and the reaction force generation members 21w and 21b give reaction forces to the player against the depressions.

When the white key 11w and the black key 11b are released, the hammers 41w and 41b pivot in the clockwise direction because of the mass of the mass bodies 41w3 and 41b3, respectively, so that the front end of the white key 11w and the black key 11b moves upward. If the undersurface of the mass bodies 41w3 and 41b3 comes into contact with the upper limit stopper member 44, the white key 11w and the black key 11b stop pivoting, so that the white key 11w and the black key 11b return to the original key-release state.

According to the keyboard apparatus according to the fifth embodiment configured to operate as above, in spite of the difference in structure between the white key 11w and the black key 11b, the player of the keyboard apparatus can depress and release both the white key 11w and the black key 11b without any feeling of strangeness, and can perceive roughly the same key touch on the white keys 11w and the black keys 11b because of the reason similar to that of the first embodiment. In the fifth embodiment, furthermore, the plurality of reaction force generation members 21w and the plurality of reaction force generation members 21b are formed integrally in one piece, so that the reaction force generation members 21w and 21b can be assembled easily.

The fifth embodiment may be also modified, similarly to the second to fourth embodiments and their modifications, such that the plurality of reaction force generation members 21w of the white keys 11w and the plurality of reaction force generation members 21b of the black keys 11b are laterally arranged in two rows in the front-rear direction. In this modification as well, furthermore, the plurality of reaction force generation members 21w may be integrally formed in one piece, with the plurality of reaction force generation members 21b being also integrally formed in one piece. Alternatively, the plurality of reaction force generation members 21w may be formed integrally with the plurality of reaction force generation members 21b.

Similarly to the modifications of the first and second embodiments, furthermore, the keyboard apparatus having the hammers 41w and 41b may be modified such that the reaction force generation members 21w and 21b are fastened to the respective upper surfaces of the mass bodies 41w3 and 41b3 of the hammers 41w and 41 b, with depression portions for depressing the respective upper surfaces of the top portions 21w2 and 21b2 of the reaction force generation members 21w and 21b being provided on the undersurface of the upper plate portion 31a of the key frame 31 which faces the hammers 41w and 41b, respectively.

### f. Other Modifications

The first to fifth embodiments and their modifications were explained as examples in which the lower end of the dome portion 21w1 of the reaction force generation member 21w of the white key 11w is lower than the lower end of the dome portion 21b1 of the reaction force generation member 21b of the black key 11b. Depending on the structure of the white keys 11w and the black keys 11b, however, there can be cases where the lower end of the dome portion 21w1 of the reaction force generation member 21w of the white key 11w is higher than the lower end of the dome portion 21b1 of the reaction force generation member 21b of the black key 11b.

The first to fifth embodiments and their modifications are configured such that the dome portion 21w and the top portion 21w2 of the reaction force generation member 21w of the white key 11w have the same shape and size as the dome portion 21b1 and the top portion 21b2 of the reaction force generation member 21b of the black key 11b. However, since the top portions 21w2 and 21b2 are hardly deformed by depression, the shape and the size of the top portions 21w2 and 21b2, particularly, the length from the upper surface to the undersurface in the direction of the axis lines Yw and Yb may be different between the top portion 21w2 and the top portion 21b2.

The first to fifth embodiments and their modifications are configured such that the reaction force generation members 21w and 21b are provided separately from the key switches 38w and 38b, respectively. Instead of such a configuration, however, the key switches 38w and 38b may be configured similarly to the reaction force generation members 21w and 21b so that the key switches 38w and 38b can be used as a reaction force generation member. In this modification, each of the dome portions 21w1 and 21b1 is to have a two-tier configuration having an inner portion and an outer portion, with a tubular less-deformable switch portion being provided between the inner portion and outer portion. In this modification, more specifically, by deformation of the outer portion, an increasing reaction force is generated against a depression of the key, while a contact provided on a board is opened or closed by the switch portion, with a reaction force against the key-depression being generated by deformation and buckling of the inner portion.

Furthermore, the first to fifth embodiments and their modifications were explained as examples in which the white keys 11w and the black keys 11b pivot about a rotational axis. However, the axis may be a hinge-type pivot axis. More specifically, the hinge-type pivot axis is configured such that a plate-like thin portion is provided on the rear end of the white key 11w and the black key 11b so that the rear end of the thin portion can be supported by a supporting member to allow the white key 11w and the black key 11b to pivot by elastic deformation of the thin portion. In this modification, however, the pivot axes Cw and Cb slightly vary with the pivoting of the white key 11w and the black key 11b, respectively. That is, the respective positions of the pivot axes Cw and Cb vary with the passage of time.

In FIGS. 16 A and B, the reaction force generating members are embodied as spring members 21w and 21b. The spring members 21w and 21b are mounted at a mounting height with respect to the frame (for example frame 31) of the musical instrument that is different for the spring members 21w and 21b. The difference in mounting height is denoted by delta L in FIG. 16 A. In this embodiment the spring members are the same, and therefore the difference in mounting height is easily discernible. Also in the case of the construction of FIG. 16 B, a difference in mounting height due to the difference in rotation can be discerned. In case that the spring members are of different type for white and black keys, the difference in mounting height can be determined by the difference in height for similar parts; if for instance the flanges 21w3 and 21b3 are shaped different (like for instance in FIG. 9), but the upper sections 21w1 and 21w2, and 21b1 and 21b2 respectively similar, then the mounting height difference can be determined by the position of the respective parts 21w1 and 21w2, and 21b1 and 21b2. The difference in mounting height can also be seen in the part of the spring members that elastically deforms (in this embodiment the dome shaped portion): for identical spring members the lower and upper sections are mounted at a different height. This can be determined for example by the difference in mounting height for the lower non-moving section of the spring members. For non-identical spring members the lower sections can be mounted at the same height, provided that the upper sections are of different mounting heights. Conversely, for non-identical spring members the upper sections can be mounted at the same height, provided that the lower sections are of different mounting heights.

What is claimed is:

1. A keyboard apparatus for an electronic musical instrument, the keyboard apparatus comprising:
a plurality of keys composed of white keys and black keys, each key pivoting about a corresponding pivot axis so that a front end of the key can move up and down, and
a plurality of reaction force generation members which are provided for the plurality of keys, respectively, and are made of an elastic body, and each of which is depressed by a depression of a corresponding key to generate a reaction force against the depression of the corresponding key, wherein
each of the reaction force generation members has a dome portion which is thin and shaped like a dome so as to be elastically deformed by depression, and a base portion which is thick and is formed integrally with the dome portion to support the dome portion, the base portion extending downward seamlessly from all circumferences of a lower end of the dome portion to jut outward from a lower end surface of the dome portion; and
a position of a point of intersection between the lower end surface of the dome portion of the white key and an axis line of the dome portion of either the white key or the black key is displaced from a position of a point of intersection between the lower end surface of the dome portion of the black key and the axis line of the dome portion of the either key.

2. The keyboard apparatus for an electronic musical instrument according to claim 1, wherein
a position of a point of intersection between the lower end surface of the dome portion of the white key and the axis line of the dome portion of the white key is displaced in a vertical direction of the keys from a position of a point of intersection between the lower end surface of the dome portion of the black key and the axis line of the dome portion of the black key.

3. The keyboard apparatus for an electronic musical instrument according to claim 1, wherein
the position of the point of intersection between the lower end surface of the dome portion of the white key and the axis line of the dome portion of the white key is displaced in a direction in which the white key and the black key extend from the position of the point of intersection between the lower end surface of the dome portion of the black key and the axis line of the dome portion of the black key.

4. The keyboard apparatus for an electronic musical instrument according to claim 1, wherein
the reaction force generation members of the white keys are formed integrally with the reaction force generation members of the black keys; and
the base portion of the white key is shaped differently from the base portion of the black key.

5. The keyboard apparatus for an electronic musical instrument according to claim 4, wherein
a step or slope is provided between an upper surface of the base portion of the white key and an upper surface of the base portion of the black key.

6. The keyboard apparatus for an electronic musical instrument according to claim 3, wherein
the reaction force generation members of the white keys are formed integrally with the reaction force generation members of the black keys; and
an undersurface of the base portion of the white key and an undersurface of the base portion of the black key are seamlessly inclined in the direction in which the white key and the black key extend.

7. The keyboard apparatus for an electronic musical instrument according to claim 1, wherein
the dome portion of the white key has the same shape and size as the dome portion of the black key.

8. A keyboard apparatus for an electronic musical instrument, the keyboard apparatus comprising:
a plurality of keys composed of white keys and black keys, each key pivoting about a corresponding pivot axis so that a front end of the key can move up and down, and
a plurality of reaction force generation members which are provided for the plurality of keys, respectively, and are made of an elastic body, and each of which is depressed by a depression of a corresponding key to generate a reaction force against the depression of the corresponding key, wherein
each of the reaction force generation members has a body portion which is thin so as to be elastically deformed by depression, and a base portion which is thick and is formed integrally with the body portion to support the body portion, the base portion extending downward seamlessly from all circumferences of a lower end of the body portion to jut outward from the lower end of the body portion; and
the lower end of the body portion of the white key is displaced in a vertical direction from the lower end of the body portion of the black key.

9. A keyboard for a musical instrument comprising
at least a white key and at least a black key, each key adapted to be depressible, and
a spring member for each key, adapted to generate a reaction force against a depression of the respective key, wherein a mounting height for the spring member for the at least one white key is different from a mounting height for the spring member for the at least one black key.

10. The keyboard according to claim 9, wherein the spring members are of similar shape.

11. The keyboard according to claim 9, wherein the spring member have a different mounting angle.

12. The keyboard according to claim 9, wherein at least one of the spring members comprises an elastic dome.

13. The keyboard according to claim 9, wherein the mounting height is determined by a lower non-moving section of the spring members with respect to a mounting position within the musical instrument.

14. The keyboard according to claim 9, wherein a spring member comprises an elastic element adapted to elastically deform under depression of the respective key.

15. The keyboard according to claim 9, wherein the elastic element is a spring.

16. The keyboard according to claim 9, wherein each key is adapted to pivot around a pivot axis, moving a front end of the key up and down.

17. The keyboard according to claim 9, wherein each reaction force generation member is made of an elastic deformable body.

18. The keyboard according to claim 9, wherein each reaction force generation member has a dome portion.

19. The keyboard according to claim 15, wherein the elastic element is a metal coil spring.
